(19) United States
(12) Patent Application Publication
(10) Pub. No.: US 2016/0098699 A1
(43) Pub. Date: Apr. 7, 2016

(54) USER-FRIENDLY MOBILE PAYMENTS SYSTEM

(71) Applicant: MasterCard International Incorporated, Purchase, NY (US)

(72) Inventor: Anshul Pandey, Haryana (IN)

(21) Appl. No.: 14/508,667

(22) Filed: Oct. 7, 2014

(51) Int. Cl. G06Q 20/32; G06Q 20/40

(52) U.S. Cl. CPC G06Q 20/322; G06Q 20/40

(57) ABSTRACT

A method includes receiving a transaction request, which includes merchant data that identifies a merchant. The merchant data is translated into an account number for the merchant. The merchant data and/or the merchant's account number is used to identify a financial institution that acts as a transaction acquirer for the merchant. A payment system transaction authorization request is routed to the identified financial institution.

### BACKGROUND

Payment card systems are in widespread use. A prominent payment card system is operated by the assignee hereof, MasterCard International Incorporated. FIG. 1 schematically illustrates a typical transaction, as carried out in a payment system 100. To initiate the transaction, a customer (not shown) visits a retail store (not shown) operated by a merchant, selects goods (not shown) that he/she wishes to purchase, carries the goods to the merchant's point of sale (POS) terminal 104, and presents his/her payment card 102 to the POS terminal 104. The POS terminal 104 reads the customer's payment card account number from the payment card 102, and then sends a transaction authorization request to an acquirer financial institution (FI) 106 with which the merchant has a relationship. The authorization request includes the payment card account number and the amount of the transaction, among other information. The authorization request is routed via a payment network 108 (which may be, for example, the well-known Banknet system operated by the assignee hereof) to the issuer financial institution 110 that issued the customer's payment card 102. Arrows 112, 114 and 116 trace the path of the authorization request from the POS terminal 104 to the issuer 110.

Assuming that all is in order, the issuer financial institution (FI) 110 transmits a favorable transaction authorization response to the POS terminal 104 through the payment card system 108 and via the acquirer FI 106. (The path of the authorization response from the issuer FI 110 to the POS terminal 104 is traced by arrows 118, 120, 122.) The transaction at the POS terminal 104 is then completed and the customer leaves the store with the goods. A subsequent clearing transaction initiated by the merchant results in a transfer of the transaction amount from the customer's payment card account 124 to an account that belongs to the merchant. The customer's payment card account 124 may be, for example, either a debit card account or a credit card account. In the former case, the clearing transaction results in the funds being debited directly from the account 124. In the latter case, the clearing transaction results in a charge being posted against the account 124, and the charge subsequently appears on the customer's monthly credit card statement.

The foregoing description of the typical transaction may be considered to be somewhat simplified in some respects. For example, a so-called merchant processing system (not shown) may be interposed between the POS terminal and the acquirer FI. As is familiar to those who are skilled in the art, a merchant processing system may be operated by or on behalf of the merchant to form part of the communications path between the acquirer FI and a considerable number of POS terminals operated by the merchant. It is also often the case that a third party transaction processing service may operate to handle payment card transactions on behalf of the acquirer and on behalf of a large number of other like financial institutions.

Moreover, the system components shown in FIG. 1 are only those required for a single transaction. In practice the payment system 100 handles numerous transactions simultaneously and has many issuers, acquirers, merchants and cardholders as participants in the system.

According to some proposals, the credentials embodied in the payment card 102 in the above example may alternatively be digitized into a mobile device such as a smartphone (not shown), which may communicate by short-range radio signaling (e.g., via NFC—“Near Field Communication”) with a suitably equipped POS device.

The present inventor has now recognized an opportunity for a system that supports highly user-friendly and flexible payments based on mobile devices, that builds on existing payments infrastructure and that does not require the mobile device or the POS device to be NFC-enabled.

### BRIEF DESCRIPTION OF THE DRAWINGS

Features and advantages of some embodiments of the present disclosure, and the manner in which the same are accomplished, will become more readily apparent upon consideration of the following detailed description taken in conjunction with the accompanying drawings, which illustrate preferred and exemplary embodiments and which are not necessarily drawn to scale, wherein:

FIG. 1 is a block diagram that illustrates a conventional payment system.

FIG. 2 is a block diagram that illustrates a mobile payments system in accordance with aspects of the present disclosure.

FIG. 3 is a block diagram that illustrates a customer's mobile telephone (smartphone) that is shown in FIG. 2 and that is provided in accordance with aspects of the present disclosure.

FIG. 4 is a block diagram representation of a server computer that provides payment services in the system of FIG. 2.

FIG. 5 is a flow chart that illustrates a process that may be performed in the system of FIG. 2.

FIG. 6 is a flow chart that illustrates additional details of the process of FIG. 5.

FIGS. 7A and 7B together form a flow chart that illustrates another process that may be performed in the system of FIG. 2.

### DETAILED DESCRIPTION

In general, and for the purpose of introducing concepts of embodiments of the present disclosure, a payment system smartphone application program (“app”) may be widely distributed to allow users to interact with a payment system via their smartphones. The user may interact with the app to sign up for a system account and to engage in payment transactions, including but not limited to, purchase transactions. In a purchase transaction at a retail store, a user may use the app to enter a merchant identifier (e.g., the merchant's mobile phone number), the transaction amount and a PIN, and may upload the entered information as a transaction request to a central payment services server computer. The payments server may identify the acquiring FI (“acquirer”) for the merchant, and may route a substantially conventional payment card system transaction authorization request to the acquirer for further routing in a substantially conventional manner via a payment network to the issuing FI (“issuer”) for the user's payment card account. Once a favorable transaction authorization response is received by the payments server, the payments server may provide payment confirmation to the merchant and to the user/customer.

In some embodiments, the user's interaction with the payment app at the point of sale may include the user's selection of one account from among a number of accounts registered with the payments server by the user. The menu of accounts available for selection by the user may have been downloaded to the smartphone/app from the payments server at the point of sale, such that the payments server also effectively functions as a wallet service provider (WSP) for the user.

In some embodiments, the user may also make peer-to-peer payments via the system via the smartphone/app. For example, the payments server may facilitate payments in which the recipient (i.e., a non-merchant in this use case) is identified by the recipient's mobile phone number.

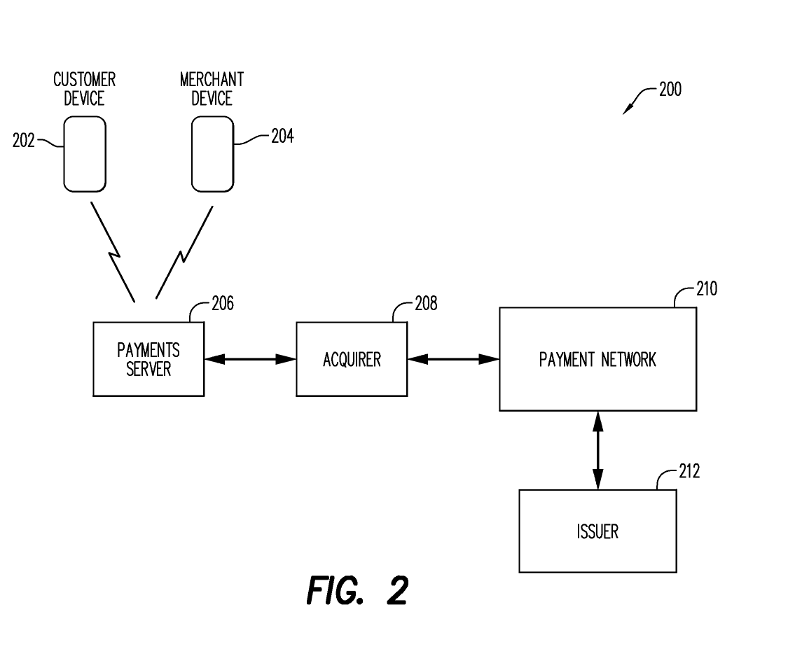

FIG. 2 is a block diagram that illustrates a mobile payments system 200 in accordance with aspects of the present disclosure. In the example embodiment illustrated in FIG. 2, only components of system 200 that operate with respect to a single transaction are shown.

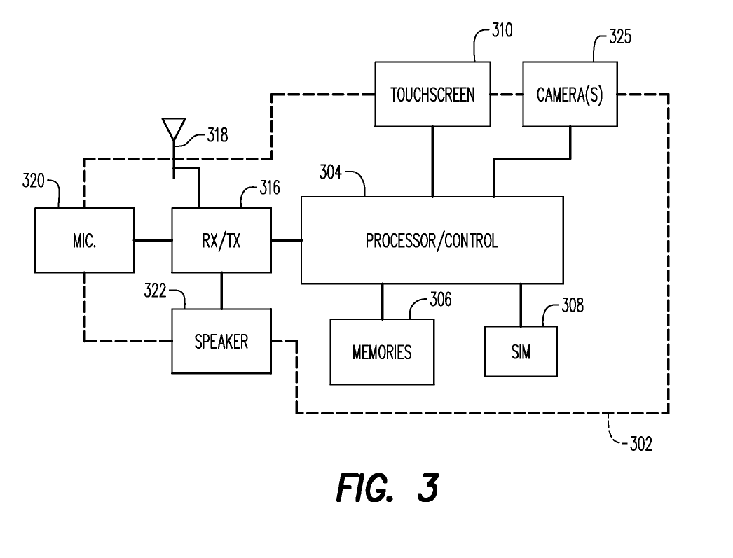

The system 200 includes a customer/user device 202, which may typically be embodied as a conventional smartphone, running an app provided in accordance with aspects of the present disclosure. Details of the customer/user device 202 are described below in conjunction with FIG. 3.

The system 200 is also depicted in FIG. 2 as including a merchant device 204, which also may be constituted by conventional smartphone hardware. In addition, the merchant device 204 may run a suitable merchant-oriented app to facilitate participation of the merchant (the user/owner of device 204) in the system 200.

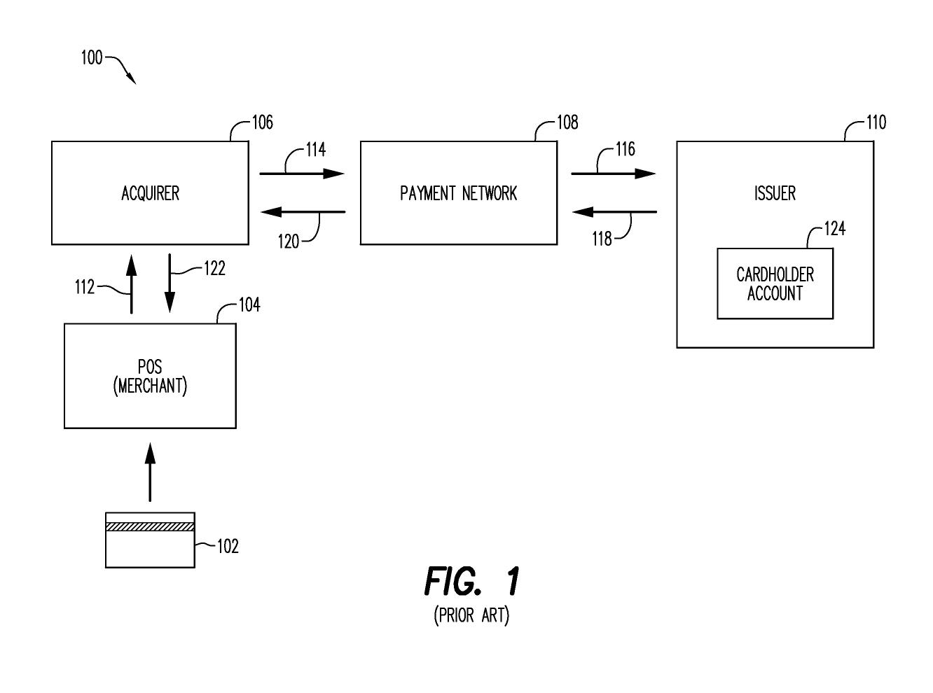

Another significant component of the system 200 is a central payment services server computer 206 (which will also be referred to as a “payments server”). Other system components include an acquirer 208, payment network 210 and issuer 212, which may substantially correspond to the components 106, 108 and 110, respectively, as mentioned above in connection with FIG. 1. Blocks 208, 210 and 212 should also be understood to represent, respectively, computer systems operated by or on behalf of the acquirer, payment network and issuer, respectively.

As in the case of the conventional system of FIG. 1, the system 200 depicted in FIG. 2 should be understood to include numerous participating parties beyond those explicitly shown in the drawing. Thus, the system 200 may include a considerable number of issuers and acquirers, and a very large number of customer/user and merchant devices. In some embodiments, more than one payment network may also be included, in the sense that the payment server 206 may initiate transaction authorization requests that, from transaction to transaction, may be for routing via different payment networks.

FIG. 3 is a block diagram of an example smartphone which may serve as the customer/user device 202 shown in FIG. 2. In its hardware aspects the customer/user device 202 may be entirely conventional, and indeed in its software aspects it also may be conventional, except that, as noted above, it may run a payment system app that allows it to provide functionality as described herein.

The customer/user device 202 may include a conventional housing (indicated by dashed line 302) that contains and/or supports the other components of the customer/user device 202. The customer/user device 202 further includes conventional control circuitry 304 (e.g., one or more processors), for controlling over-all operation of the customer/user device 202. As is conventional, the control circuitry 304 is suitably programmed to allow the customer/user device 202 to engage in data communications and/or text messaging with other devices, and to allow for interaction with web pages accessed via browser software, which is not separately shown. Other components of the customer/user device 202, which are in communication with and/or controlled by the control circuitry 304, include: (a) one or more memory devices 306 (e.g., program and working memory, etc.); (b) a conventional SIM (subscriber identification module) card 308; and (c) a conventional touch screen 310 for receiving user input and for displaying output to the user.

As is familiar to those who are skilled in the art, the customer/user device 202 may be programmed with a number of software programs, including, for example, a mobile operating system (OS), a mobile browser, and a number of other application programs, including the above-mentioned payment system app. The software programs may be stored in the memories 306 and may include program instructions that control the processor/control circuit 304, such that the processor/control circuit 304 is operative with the program instructions to provide functionality as described herein relative to the customer/user device 202.

The customer/user device 202 also includes conventional receive/transmit circuitry 316 that is also in communication with and/or controlled by the control circuitry 304. The receive/transmit circuitry 316 is coupled to an antenna 318 and provides the communication channel(s) by which the customer/user device 202 communicates via the mobile network (not shown). The customer/user device 202 further includes a conventional microphone 320, coupled to the receive/transmit circuitry 316. Of course, the microphone 320 is for receiving voice input from the user. In addition, a speaker 322 is included to provide sound output to the user, and is coupled to the receive/transmit circuitry 316.

As for the user interface of the customer/user device 202, in addition to the above-mentioned touchscreen 310, in many embodiments the customer/user device 202 may also include at least a few user-operable switches (not shown), such as a “home” key, a “menu” key, a reset/on/off switch, a sound volume control, etc. Further, the speaker 322 may functionally form part of the user interface.

The customer/user device 202 may also include one or more cameras 325, as is common in many models of smartphones.

Unlike smartphones adapted to provide payment functions according to some previous proposals, the customer/user device 202 may lack any NFC or other short-range communications capability, and thus may not have the loop antenna that is commonly included in many previously proposed payment-enabled smartphones. In other words, the hardware aspects of the customer/user device 202 may be rather inexpensive relative to the payment capabilities offered by the customer/user device 202 in accordance with aspects of this disclosure.

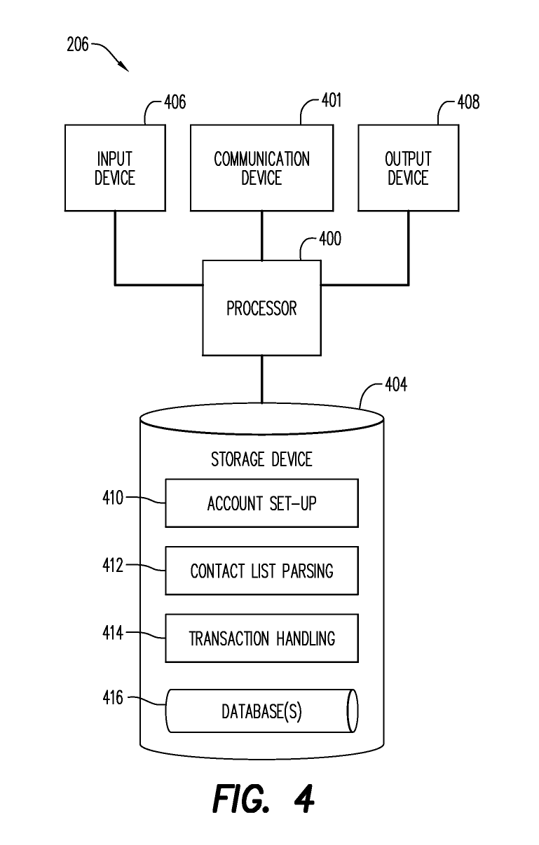

FIG. 4 is a block diagram representation of an example payments server 206 which may be operated as part of the system 200 shown in FIG. 2.

The payments server 206 may be conventional in its hardware aspects but may be controlled by software to cause it to operate in accordance with aspects of the present invention. For example, the payments server 206 may be constituted, at least in part, by conventional server computer hardware.

The payments server 206 may include a computer processor 400 operatively coupled to a communication device 401, a storage device 404, an input device 406 and an output device 408. The storage device 404, the communication device 401, the input device 406 and the output device 408 may all be in communication with the processor 400.

The computer processor 400 may be constituted by one or more conventional processors. Processor 400 operates to execute processor-executable steps, contained in program instructions described below, so as to control the payments server 206 to provide desired functionality.

Communication device 401 may be used to facilitate communication with, for example, other devices (such as customer/user devices, merchant devices, and/or acquirer computers). Communication device 401 may, for example, have capabilities for sending and receiving messages over mobile telephone networks, as well as engaging in data communication over conventional computer-to-computer data networks.

Input device 406 may comprise one or more of any type of peripheral device typically used to input data into a computer. For example, the input device 406 may include a keyboard and a mouse. Output device 408 may comprise, for example, a display and/or a printer.

Storage device 404 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory.

Storage device 404 stores one or more programs for controlling processor 400. The programs comprise program instructions that contain processor-executable process steps of payments server 206, including, in some cases, process steps that constitute processes provided in accordance with principles of the present disclosure, as described in more detail below.

The programs may include one or more conventional operating systems (not shown) that control the processor 400 so as to manage and coordinate activities and sharing of resources in the payments server 206, and to serve as a host for application programs (described below) that run on the payments server 206.

The programs stored in the storage device 404 may also include one or more account set-up programs 410 that control the processor 400 to enable the payments server 206 to provide account set-up and user enrollment functions for prospective users of the payment system 200. In addition, though not separately shown, the storage device 404 may store programs to facilitate enrollment of merchants with the payments server 206. Details of the functionality provided by the account set-up program 410 will be described below.

The storage device 404 may also store a contact list parsing application program 412 for helping users to identify individuals included in the users' smartphone contacts list who are also subscribers to the payment system 200. Details of this program, as well, will be described below.

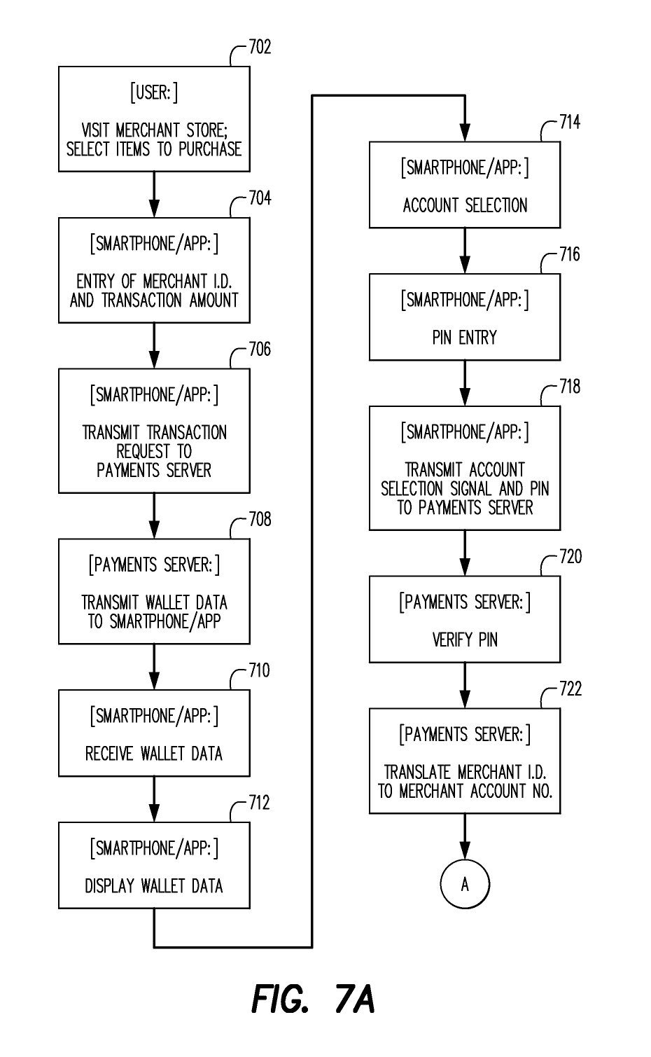

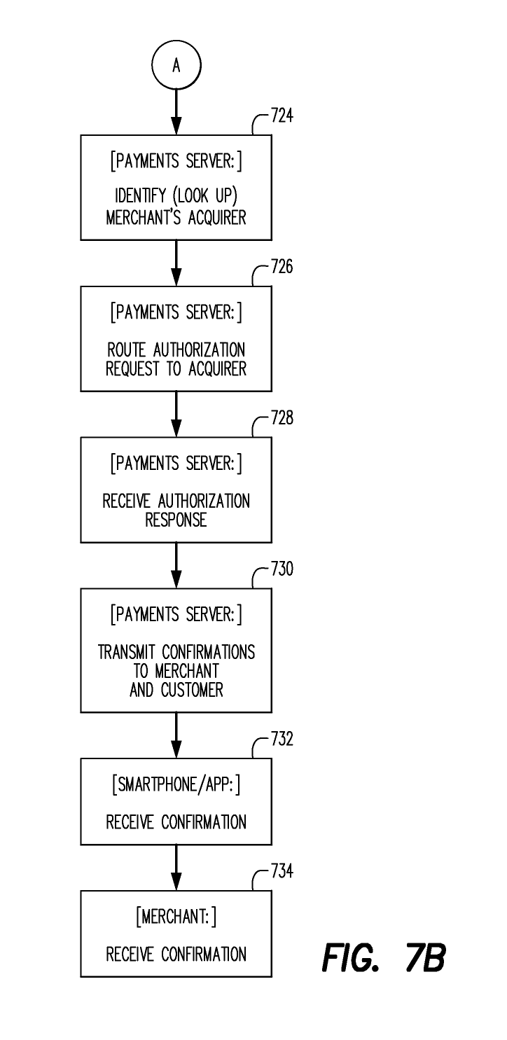

Another application program that may be stored by the storage device 404 is for handling individual transactions and is indicated by reference numeral 414 in FIG. 4. Details of operation of the transaction handling application 414 will be discussed hereinbelow, particularly with reference to FIGS. 7A-7B.

The storage device 404 may also store, and the payments server 206 may also execute, other programs, which are not shown. For example, such programs may include a reporting application, which may respond to requests from system administrators for reports on the activities performed by the payments server 206. The other programs may also include, e.g., one or more data communication programs, a database management program, website hosting software, device drivers, etc.

Reference numeral 416 in FIG. 4 indicates one or more databases that are maintained by the payments server 206 on the storage device 404. Among these databases may be a consumer/user database, a merchant database, an acquirer database and a transaction database.

The application programs of the payments server 206 as described above may be combined in some embodiments, as convenient, into one, two or more application programs.

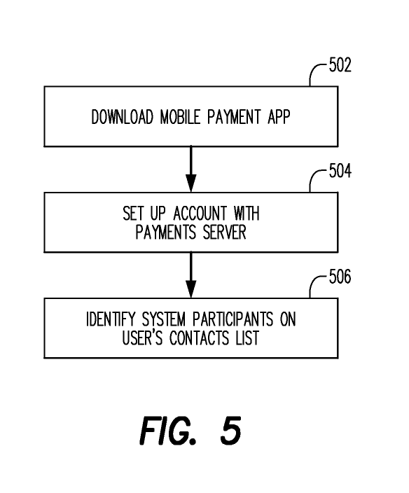

FIG. 5 is a flow chart that illustrates a process that may be performed in the payment system 200 of FIG. 2. In particular, FIG. 2 illustrates a process by which a user may become enrolled in the payment system 200, and may prepare to make use of the payment system 200.

At 502 in FIG. 5, the user may download the above-mentioned payment system app to the customer/user device 202. In some cases, this may occur via interaction between the customer/user device 202 and a website hosted by the payments server 206. In addition or alternatively, the payment system app may be available, possibly as a free download, from a well-known internet source of smartphone apps, such as the “App Store” portion of the iTunes® e-commerce site and/or the “Google Play” e-commerce site. Thus, in at least some embodiments, the customer/user device 202 may download the payment system app from a source other than the payments server 206.

At 504 in FIG. 5, the user may interact with the payments server 206 via the payment system app to open a user account to be maintained on the payment server 206. The user may accordingly enter, via the app, his/her name and contact information, and also may enter information indicative of one or more payment card accounts that the user wishes to access in transactions to be performed via the payment system 200. This information may include, for example, a PAN (primary account number) or payment token that corresponds to each payment card account to be registered into the payments server 206. The user may enter related information such as a card expiration date, and/or other information like that entered in a conventional online purchase transaction. In addition, via the payment system app, the payments server 206 may prompt the user to enter a transaction PIN (personal identification number—e.g., a four-digit code) that the user will be required to enter in connection with each transaction performed via the payment system 200. The payments server 206 may store the PIN in association with the other information relating to the user's account.

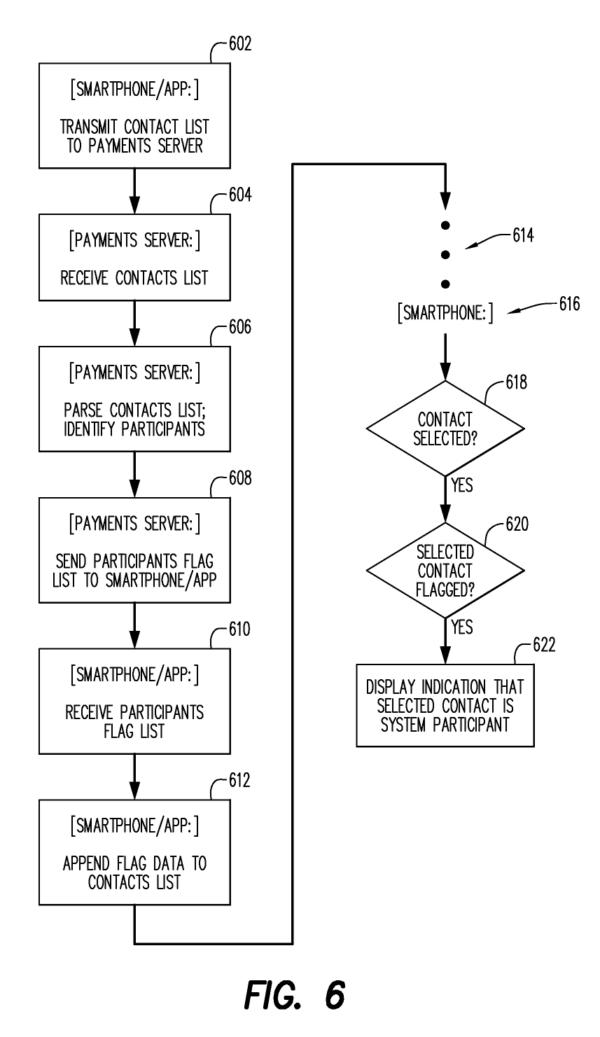

At 506 in FIG. 5, a process may occur in which the contact list on the customer/user device 202 is scanned to identify individual contacts who are already participants/subscribers in the payment system 200. As will be seen, this may facilitate subsequent peer-to-peer payment transactions. Details of the process of FIG. 5 are illustrated in FIG. 6, which is a flow chart, and which will now be discussed. For purposes of illustration only, the customer device 202 is indicated as a smartphone.

Referring, then, to FIG. 6, at block 602, the payment system app may operate to cause the customer/user device 202 to transmit the user's contacts list to the payments server 206. In some embodiments, only a portion of the contacts list data may be transmitted, say only contact names and phone numbers/mobile numbers. That is, the payment system app may strip out all other information from the contacts list, before causing the remaining information to be transmitted to the payments server 206. (For purposes of the appended claims, the partial contact list data transmitted from the customer/user device 202 shall also be deemed to be a “contacts list.”)

In some embodiments, the payment system app may interact with the contact list on the customer/user device 202 as required to result in satisfactory performance of block 602. In other actions of the payment system app, it may interact with the payments server 206 in regard to consumers, or small- or medium-sized businesses, to access the mobile phone numbers of such entities. In still other actions of the payment system app, it may interact with the payments server 206 to access a unique merchant identifier that points to a large (or other type) of business.

At 604 in FIG. 6, the payments server 206 receives the contacts list information transmitted from the customer/user device 202/payment system app. At 606, the payments server 206 parses/analyzes the user's contacts list to determine what individuals on the list are already registered with the payments server 206. For example, the contacts list may be cross-matched against the list of system participants maintained in the payments server 206. This may be done, e.g., by phone number. As a result of this operation, the payments server 206 identifies all the individuals on the user's contacts list who are system participants.

At 608, the payments server 206 transmits, to the customer/user device 202, data sufficient to indicate the individuals identified at block 606. These individuals are to be flagged as payment system participants in the contacts list as maintained in the customer/user device 202.

At 610, the customer/user device 202 receives the “to-be-flagged” data transmitted by the payments server 206 at block 608. At 612, the customer/user device 202 appends the data to the contacts list stored in the customer/user device 202, or otherwise modifies the contacts list, to flag the system participants who are on the contacts list.

Thereafter, in operations indicated in FIG. 6 after an ellipsis 614, the customer/user device 202 is operable so that the user is informed of individuals on his/her contacts list that are participants in the payment system 200 and hence are candidates for a peer-to-peer payment transaction via the payment system 200.

As indicated at 616 in FIG. 6, subsequent operations indicated in FIG. 6 all involve the customer/user device 202. Thus, at decision block 618 in FIG. 6, the customer/user device 202 determines whether the user has selected a particular entry in the contacts list. If so, then decision block 620 may follow decision block 618. At decision block 620, the customer/user device 202 determines whether the selected individual on the contacts list has been flagged in the customer/user device 202 as a participant in the payment system 200. If such is the case, then block 622 may follow decision block 620. At block 622, the customer/user device 202 may display an appropriate symbol (e.g., a logo associated with the payment system 200) in association with the displayed contacts item to indicate to the user that the individual in question is a system participant. In some embodiments, information other than a symbol/logo may be displayed (e.g., color coding) to indicate the individual is a system participant. In some embodiments, when the contacts list is displayed in scrollable form, system participants may be designated by a symbol/logo in the list, without requiring that the user have previously selected the individual in question. In some embodiments, either on the list or on an individual flagged entry, clicking/touching on the symbol/logo adjacent to the contact's name may launch the payment system app to trigger a peer-to-peer payment/funds transfer transaction from the user of the customer/user device 202 to the contact in question.

In some embodiments, after initial set up of the user's account, including the contacts list scanning process of FIG. 6, the payment system app may periodically (say every few weeks) prompt the user to re-initiate the process of FIG. 6 to flag further system participants from the contacts list who may have either (a) been added to the contacts list since the last scan, or (b) become system participants since the last scan.

FIGS. 7A and 7B together form a flow chart that illustrates another process that may be performed in the payment system 200 of FIG. 2. In particular, FIGS. 7A/7B illustrate a typical consumer-to-merchant payment transaction in accordance with some aspects of the present disclosure. For purposes of illustration only, the customer device 202 is indicated as a smartphone.

At 702 in FIG. 7A, the user of the customer/user device 202 may (with the customer/user device 202 in his/her possession) visit a merchant's retail store location, select items for purchase, and take the items to a checkout counter. In some embodiments, the checkout counter may be very informal and may lack a conventional POS device. Rather, the store proprietor/manager/sales associate may simply have a smartphone at hand that runs a payment system app published by the payment system 200 and tailored for use by merchants who participate in the payment system 200. (The hardware aspects of the merchant smartphone, i.e., device (reference numeral 204 in FIG. 2) may be similar to or the same as the smartphone hardware configuration described above in connection with FIG. 3.)

At 704, the user interacts with the payment system app on the customer/user device 202 to launch the beginning phases of a payment transaction and to enter the merchant's mobile telephone number and/or another piece of information that identifies the merchant that is to benefit from the ensuing transaction. At the same time, via the app, the user may enter the transaction amount (total amount to be paid to the merchant) into the customer/user device 202. In some embodiments, all of this information may be numerical and may be entered into the customer/user device 202 by the user via a virtual numeric keypad displayed on the touchscreen 310 (FIG. 3) of the customer/user device 202.

Upon completion of entry of the merchant identifier and transaction amount, the payment system app may cause the customer/user device 202 to transmit that information to the payments server 206 as part of a payment system transaction request, as represented by block 706 in FIG. 7A. Upon receiving the transaction request, the payments server 206 may respond (block 708) by transmitting/downloading to the customer/user device 202/payment system app a menu of accounts (e.g., payment card accounts and/or other types of financial accounts) that the user has previously registered with the payments server 206 as eligible for use in payment transactions. This menu may be referred to as “wallet data” in that the registration of the user's accounts with the payments server 206 is essentially equivalent to establishing a digital wallet for the user with the payments server 206.

At 710 in FIG. 7A, the customer/user device 202/payment system app receives the wallet data/account menu from the payments server 206. At 712, the customer/user device 202 displays the wallet data/account menu to the user via the touchscreen 310. At 714, the user (in similar fashion to using a digital wallet) may tap one of the menu items displayed on the screen to indicate selection of the corresponding account for use in the current transaction. At 716, the payment system app may cause the customer/user device 202 to prompt the user to enter his/her transaction PIN, and the user may do so. Again this may be done via a virtual numeric keypad displayed on the touchscreen. (In some embodiments, for purposes of improved security, the customer/user device 202 may not permanently store the user's transaction PIN.)

In some embodiments, in association with displaying the wallet data and/or prompting for PIN entry, the customer/user device 202/payment system app may also display the merchant's name to allow the user to confirm that the transaction is being directed in accordance with the user's intention.

At 718, the customer/user device 202/payment system app may transmit to the payments server 206, the transaction PIN—as entered by the user—and a signal indicative of the account selected by the user at 714 from the account menu. Upon receiving this information from the customer/user device 202, the payments server 206 may verify the transaction PIN (block 720), by comparing the PIN as received against the PIN value that the user previously stored in the payments server 206.

At 722, the payments server 206 may translate the merchant mobile telephone number (or other merchant identifier) into an account number that identifies a financial account that belongs to the merchant.

Next, at 724 in FIG. 7B, the payments server 206 may use either or both of the merchant mobile phone number/merchant identifier and the merchant account number to look up/identify the acquiring FI (acquirer) that provides transaction acquiring services to the merchant.

At 726, the payments server 206 may route a substantially conventional payment card system transaction authorization request to the acquirer identified at 724. In some embodiments, this transaction authorization request may be similar to the authorization request described above in connection with FIG. 1. As is customary with authorization requests in payment card systems, the authorization request initiated by the payments server 206 (in essence, on behalf of the merchant), may be routed from the acquirer 208 (FIG. 2) to the issuer 212 of the user's selected account, via the payment network 210.

Assuming all is in order with the account that the user selected for the transaction, then the issuer 212 (FIG. 2) may issue a substantially conventional transaction authorization response, indicating approval of the requested payment card account transaction, to be routed via the payment network 210 and the acquirer 208 to the payments server 206. The receipt of the transaction authorization response by the payments server 206 is indicated by block 728 in FIG. 7B.

At 730, the payments server 206 transmits messages to the customer/user device 202 and to the merchant device 204 (FIG. 2), to confirm that payment for the current purchase transaction has been successfully processed via the payment system 200. In some embodiments, the payment server 206 may address the confirmation messages to the customer/user device 202 and the merchant device 204 by using the respective mobile phone numbers for those devices.

At 732, the customer/user device 202 receives the confirmation message from the payments server 206 and at 734 the merchant device 204 receives the confirmation message from the payments server 206. It will be appreciated that each of the customer/user device 202 (via the payment system app), and the merchant device 204 (via the merchant-oriented version of the app) may display to the respective users thereof information to indicate that the payment portion of the purchase transaction is complete/has been confirmed. Accordingly, the purchase transaction is concluded, and the customer/user is free to leave the merchant's store with the user's purchased items.

In some embodiments, the confirmation message received at 732 by the customer/user device 202 may contain enough information to serve as an electronic transaction receipt for the purchase transaction. In addition or alternatively, the payments server 206 may provide another message to the customer/user device 202 and/or to the payment system app and/or to the customer's e-mail account and/or to another device used by the customer (e.g., a personal or laptop computer) to serve as an electronic receipt for the purchase transaction.

A transaction such as that illustrated in FIGS. 7A/7B can take place, for example, in a small retail store or at an informal merchant's market stall, or the like, while requiring minimal investment by the customer and merchant, and with great convenience for both customer and merchant and great flexibility for the customer.

A transaction process flow like that shown in FIGS. 7A/7B can also be applicable to a larger, more formal merchant, and even to a very large retailer with many store locations. For example, each sales employee of the retailer may be supplied with a smartphone running a suitable app. Each sales employee smartphone may have a mobile phone number that has been associated with the retailer in the records of the payments server 206. Alternatively, the customer may be provided with a suitable merchant identifier (for inclusion in the transaction request, block 706, FIG. 7A) that is not a mobile phone number. Again, the merchant identifier may have previously been associated with the retailer in the records of the payments server 206 and may point to a particular smartphone operated by the retailer's employees.

As another alternative, generally conventional POS devices (not shown in FIG. 2) may be employed by the retailer and may be programmed with suitable apps so that the POS devices are tied in to the payment system 200, at least sufficiently to receive the confirmation message indicated at blocks 732 and 734 in FIG. 7B.

The transaction process of FIGS. 7A/7B may also, in some embodiments, be adapted with minimal changes to an online purchase transaction. In such a case, the e-commerce website may display to the customer an appropriate merchant phone number or other merchant identifier for the user/customer to enter into the customer/user device 202/payment system app at block 704 in FIG. 7A. The e-commerce merchant may receive the confirmation message (blocks 730, 734 in FIG. 7B) from the payments server 206 to consummate the online purchase transaction. In another variation, the user may input his/her mobile phone number into the e-commerce website, which may then communicate with the customer/user device 202 to cause the payment system app to be activated on the customer/user device 202. The merchant's e-commerce server may populate the merchant identifier and transaction amount into the payment system app on the customer/user device 202, and the payment system app may then automatically, or with the user's consent, launch the transaction request (block 706, FIG. 7A) to the payments server 206.

In these online purchase transaction examples, the customer may enter his/her mobile phone number into the e-commerce webpage data entry screen to allow the merchant to tie the subsequent confirmation message from the payments server 206 to the current transaction via the customer's mobile phone number.

Up to this point, customer-to-merchant payment transactions have been described in the context of the payment system 200. It should also be understood that the payment system 200, and particularly the payments server 206 may also, in some embodiments, facilitate so-called “P2P” (i.e., person-to-person or peer-to-peer) payment transactions. In some embodiments, the process for such payments may be consistent with prior proposals for remittance or in-country funds transfers using a payment card account system as the “backbone” for such payments. The payment system app in the payment-sender's smartphone (i.e., the user device 202) may facilitate launching a P2P payment transaction. The sender may, for example, simply select the payment recipient via the app (e.g., via a payment system symbol or logo positioned near the recipient's name on the display of the user device 202). The app may prompt the sender to enter the amount of funds to be transferred, and then may communicate with the payments server 202 to indicate the recipient identifier (e.g., recipient mobile phone number) and payment transaction amount. The payments server 206 may operate as a payment services provider for the sender in connection with the P2P payment transaction. With information received from the app, the payments server 206 may have the sender's and recipient's mobile phone numbers and may translate those numbers into payment card system account numbers for the sender and the recipient to be used in the payment-card-system-based P2P payment transaction. In other cases, or in other embodiments, the sender may be presented with an account menu/wallet data (e.g., downloaded from the payments server 206 to the user device 202/payment system app) to allow the user to select an account from which to fund the P2P payment transaction.

In some embodiments, and/or for some transactions, the sender may enter the recipient's mobile phone number into the payment system app on the user device 202 to indicate selection of the recipient for the payment transaction.

In general, for both customer-to-merchant (“C2M”) and P2P payment transactions, in addition to or as an alternative to account selection by the sender/customer, arrangements may have been made with the payments server 206 such that the sender/customer has pre-designated a default financial account (or the user may have only one account registered in the payments server 206), such that account selection by the customer/sender may not be required for a given payment transaction.

In some embodiments, for a C2M transaction, there is no fee charged to the customer, and the usual payment card account system transaction interchange arrangements may apply. In some embodiments, for a P2P transaction, a fee may be charged to the sender in addition to the amount of the funds transfer.

In some embodiments, and/or for some transactions, the user may not be required to use a mobile device and the payment system app to launch the transaction. For example, the user may be permitted to access his account on the payments server 206 via a browser program (running, e.g., on a conventional personal or laptop computer) interacting with a website hosted by the payments server 206. The user may then be permitted to initiate a payment transaction in the payment system 200 via the payments server website.

In some embodiments, business-to-business (B2B) purchase transactions may proceed in a similar manner to the process illustrated in FIGS. 7A/7B.

One security feature of the payment system 200, according to some embodiments, and as mentioned above, calls for the user to enter and submit a transaction PIN to the payments server 206 (via the payment system app) in connection with each transaction, with the transaction PIN having been previously stored by the user in the payments server 200 upon set-up of the user's account. In some embodiments, the payments server 206 may enforce a limit of three incorrect attempts to enter the transaction PIN. If the limit is reached, the payments server 206 may block the user's account. To unblock the account, the user may be required to telephone in to the system's customer-care call center (not shown). The call center may require the user to successfully perform a procedure to verify his/her identity in order to unblock the account.

According to another possible security measure, the payments server 206 may have a capability to confirm that the location of the customer/issuer device 202 matches the merchant's location at the time of the transaction. In addition or alternatively, the payments server 206 may have a capability to verify the internet protocol address of the customer/user device 202. As still another possible additional or alternate measure, the payments server 206 may operate to forbid multiple logins to a single user account.

According to some embodiments, the payments server 206 may implement a full array of financial service computing system security features, including compliance with the so-called PCI (Payment Card Industry) requirements.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

As used herein and in the appended claims, a “server” includes a computer device or system that responds to numerous requests for service from other devices.

The flow charts and descriptions thereof herein should not be understood to prescribe a fixed order of performing the method steps described therein. Rather the method steps may be performed in any order that is practicable.

As used herein and in the appended claims, the term “payment card system account” includes a credit card account, a deposit account that the account holder may access using a debit card, a prepaid card account, or any other type of account from which payment transactions may be consummated. The terms “payment card system account” and “payment card account” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card, debit card, prepaid card, or other type of payment instrument, whether an actual physical card or virtual.

As used herein and in the appended claims, the term “payment card system” refers to a system for handling purchase transactions and related transactions. An example of such a system is the one operated by MasterCard International Incorporated, the assignee of the present disclosure. In some embodiments, the term “payment card system” may be limited to systems in which member financial institutions issue payment card accounts to individuals, businesses and/or other organizations.

Although the present disclosure has been described in connection with specific exemplary embodiments, it should be understood that various changes, substitutions, and alterations apparent to those skilled in the art can be made to the disclosed embodiments without departing from the spirit and scope of the disclosure as set forth in the appended claims.

What is claimed is:

1. A method comprising:
receiving a transaction request at a computer, the transaction request including merchant data that identifies a merchant;
translating, in the computer, the merchant data to an account number for the merchant;
using at least one of the merchant's account number and the merchant data to identify, in the computer, a financial institution that acts as a transaction acquirer for the merchant; and
routing a payment system transaction authorization request from the computer to the identified financial institution.

2. The method of claim 1, further comprising:
receiving, in the computer, a payment system transaction authorization response routed via the identified financial institution.

3. The method of claim 2, wherein the payment system transaction authorization response originated from an issuer of a payment card account that belongs to a customer who originated the transaction request received at the computer.

4. The method of claim 3, further comprising:
transmitting to the merchant, from the computer, a confirmation of payment for the requested transaction.

5. The method of claim 4, wherein:
the merchant data includes the merchant's mobile telephone number; and
the computer transmits the confirmation to a mobile telephone belonging to the merchant, the confirmation addressed to the merchant's mobile telephone by using the merchant's mobile telephone number.

6. The method of claim 3, wherein the transaction request received at the computer was transmitted by a mobile telephone that belongs to the customer.

7. The method of claim 6, wherein the payment system transaction authorization request routed from the computer includes transaction information, the transaction information including a transaction amount, the transaction information received by the computer from the mobile telephone that belongs to the customer.

8. The method of claim 3, further comprising:
receiving an account selection signal in said computer prior to said routing step, the account selection signal for selecting said payment card account from among a plurality of payment card accounts that belong to the customer.

9. The method of claim 3, wherein the routed payment system transaction authorization request includes a payment card account number that corresponds to said payment card account that belongs to the customer

10. An apparatus comprising:
a processor; and
a memory in communication with the processor, the memory storing program instructions, the processor operative with the program instructions to perform functions as follows:
receiving a transaction request, the transaction request including merchant data that identifies a merchant;
translating the merchant data to an account number for the merchant;
using at least one of the merchant's account number and the merchant data to identify a financial institution that acts as a transaction acquirer for the merchant; and
routing a payment system transaction authorization request to the identified financial institution.

11. The apparatus of claim 10, wherein the processor is further operative with the program instructions to receive a payment system transaction authorization response routed via the identified financial institution.

12. The apparatus of claim 11, wherein the payment system transaction authorization response originated from an issuer of a payment card account that belongs to a customer who originated the received transaction request.

13. The apparatus of claim 12, wherein the processor is further operative with the program instructions to transmit to the merchant a confirmation of payment for the requested transaction.

14. The apparatus of claim 13, wherein:
the merchant data includes the merchant's mobile telephone number; and
the confirmation is transmitted to a mobile telephone belonging to the merchant, the confirmation addressed to the merchant's mobile telephone by using the merchant's mobile telephone number.

15. The apparatus of claim 12, wherein the received transaction request was transmitted by a mobile telephone that belongs to the customer.

16. The apparatus of claim 15, wherein the routed payment system transaction authorization request includes transaction information, the transaction information including a transaction amount, the transaction information received from the mobile telephone that belongs to the customer.

17. A method comprising:
transmitting a contacts list from a mobile telephone to a server computer, the contacts list containing a plurality of contacts, and including a contact name and contact telephone number for each of said plurality of contacts;
receiving a response message in the mobile telephone from the server computer, the response message identifying ones of said contacts as participants in a mobile payments application scheme; and
appending data to said contacts list in said mobile telephone, the appended data for flagging, in said contacts list in said mobile telephone, said identified ones of said contacts.

18. The method of claim 17, further comprising:
receiving in said mobile telephone an indication from a user that the user is selecting a contact from the contacts list;
determining in said mobile telephone whether said selected contact is flagged by said appended data; and
displaying, for said selected contact, by the mobile telephone, an indication that the selected contact is a participant in said mobile payments application scheme.

19. The method of claim 18, wherein said mobile telephone runs a mobile payments application program in accordance with the mobile payments application scheme.

20. The method of claim 19, wherein the mobile payments application program in said mobile telephone receives said response message and implements said flagging.
